(19) United States
(12) Patent Application Publication
(10) Pub. No.: US 2024/0286771 A1
(43) Pub. Date: Aug. 29, 2024

(54) AIRCRAFT AND METHOD FOR CLEANING SURFACES

(71) Applicant: Ronald LILLEG-STAUDENHERZ, Hart bei Graz (AT)

(72) Inventor: Ronald LILLEG-STAUDENHERZ, Hart bei Graz (AT)

(21) Appl. No.: 18/571,249

(22) PCT Filed: Jun. 15, 2022
(86) PCT No.: PCT/AT2022/060202

§ 371 Date: Dec. 17, 2023

(30) Foreign Application Priority Data
Jun. 17, 2021 (AT) A50490/2021

(51) Int. Cl. B64U 10/14; B64U 20/30; B64U 101/29

(52) U.S. Cl. CPC B64U 10/14; B64U 20/30; B64U 2101/29; B64U 2201/20

(57) ABSTRACT

The invention relates to an aircraft (1), more particularly a drone, and to a corresponding method for cleaning especially substantially flat surfaces that are preferably delimited by a frame (5), especially of windows or doors. The aircraft comprises at least one drive device (2), more particularly four drive devices (2), a controller, and a cleaning device (3), and at least one sensor (4) is provided on the aircraft (1) and the at least one sensor (4) is designed to control the aircraft on the surface.

The invention relates to an aircraft and a method according to the preambles of the independent claims.

Different aircraft are known from the prior art. For example, aircraft are known in which the surfaces to be cleaned, such as doors or windows, have to be recognized themselves. The disadvantage of such aircraft is that the surface to be cleaned must first be detected and must then be flown to independently. Furthermore, these conventional aircraft must be secured to the window.

The object of the invention is to overcome the disadvantages of the prior art. In particular, it is the object of the invention to create an aircraft for cleaning surfaces, which is simple, uncomplicated and can be used without the need for safety measures. Further objects of the invention include, among other things, creating a method for cleaning surfaces.

The object according to the invention is achieved in particular by the features of the independent claims.

The invention relates in particular to an aircraft, in particular a drone, for cleaning surfaces, in particular substantially flat surfaces.

These areas are preferably delimited by a frame and are designed in particular as windows or doors.

The aircraft preferably comprises at least one drive device, in particular four drive devices, a controller and a cleaning device.

It is preferably provided that at least one sensor is provided on the aircraft.

It is preferably provided that the at least one sensor for controlling the aircraft is formed on the surface.

The aircraft can be designed as a helicopter, quadrocopter, hexacopter or octocopter.

The drive device can be designed as a lifting device.

The drive device can optionally comprise at least one motor device and at least one rotor and/or a propeller.

The controller can be configured to stabilize, control, navigate and/or stabilize the aircraft, preferably on the surface, preferably exclusively based on the data from the at least one sensor, in particular automatically.

In particular, it is provided that the aircraft comprises one, two, three, four, five, six, seven, eight, nine, ten or more than ten drive devices.

The movement and steering of the aircraft can take place via the control of the drive device, in particular the control of the speed of the at least one rotor of the drive device.

The contact pressure on the surface, in particular the contact pressure required for cleaning, can be achieved by controlling the drive device, in particular by controlling the speed of the at least one rotor of the drive device.

The aircraft can be operated wirelessly if necessary. This means that the aircraft may obtain the necessary energy, in particular exclusively, from an energy storage device arranged on the aircraft.

The aircraft can be operated with a cable if necessary. This means that the aircraft may obtain the necessary energy, in particular exclusively, via the cable, which is preferably connected to an energy source.

In the context of the invention, a surface can be understood to mean a largely smooth surface, such as a window or a door, in particular a surface to be cleaned.

In the context of this invention, a frame can be understood to mean a side border of a window or a door, in particular a window frame or a door frame.

The aircraft can be configured to clean an area that is delimited at least on one side by a frame.

The aircraft can be configured to clean a surface that is designed without a frame.

If necessary, the aircraft, in particular the at least one drive device, the at least one controller and/or the at least one sensor, is designed to be splash-proof or waterproof.

If necessary, it is provided that a holding device is provided on the aircraft, and that the holding device is designed to fix the aircraft to the surface, in particular in a materially bonded and/or frictional manner.

If necessary, it is provided that the holding device comprises an adhesive tape. If necessary, it is provided that the holding device is designed as a suction cup. For example, the holding device can comprise a conventional gecko tape.

The holding device can be arranged on one side of the aircraft, in particular on its top side.

The aircraft can be connected to the surface in a materially bonded manner, in particular via the holding device, which comprises an adhesive tape. The aircraft can be connected to the surface in a form-fitting or frictional manner, in particular via the holding device, which comprises a suction cup.

If necessary, it is provided that the cleaning device comprises a cleaning roller that can be rotated by a rotating device, in particular an electric motor.

If necessary, it is provided that the rotating device is arranged inside the cleaning roller.

If necessary, it is provided that the cleaning device comprises a substantially plate-shaped cleaning cloth.

If necessary, it is provided that the cleaning cloth is pivotably connected to the aircraft via a connecting device, in particular an eccentric.

If necessary, it is provided that the end regions, in particular the corners, of the cleaning device are rounded.

If necessary, it is provided that the cleaning device is connected to the aircraft via a shock absorber device.

If necessary, it is provided that the end regions of the cleaning device are made of a soft material such as rubber or a sponge material. This makes it possible to reduce and/or prevent the cleaning device from getting caught on the surface.

If necessary, it is provided that cleaning threads, in particular nylon threads or steel wool threads, and/or cleaning strips are arranged on the cleaning device, in particular the cleaning roller and/or the cleaning cloth.

If necessary, it is provided that the cleaning threads and/or cleaning strips are designed in such a way that they can be pressed onto the surface and/or attracted to the surface by centrifugal force.

The cleaning threads can optionally be designed to remove stubborn dirt, in particular fly droppings, from the surface. These cleaning threads can protrude from the cleaning device.

If necessary, it is provided that cleaning strips are attached to the cleaning device, which, as in particular in a conventional car wash, can be pressed onto the surface by centrifugal force.

The cleaning threads can optionally be designed to knock the dirt off the surface.

The cleaning device may comprise microfiber or be formed from microfiber.

The cleaning device can comprise at least one antistatic cloth or at least one ammonia-like product. The cleaning device can be formed from at least one antistatic cloth or a product similar to ammonia.

If necessary, it is provided that the cleaning device comprises an ultrasonic device and/or a dry ice device for cleaning the surface to be cleaned.

If necessary, it is provided that the cleaning device comprises a sliding device.

If necessary, it is provided that the sliding device projects beyond the cleaning device, in particular in its end regions, so that the cleaning device is arranged at a distance from the surface to be cleaned during cleaning and in particular only the cleaning threads and/or the cleaning strips of the cleaning device come into contact with the surface to be cleaned.

It can be provided that only the cleaning threads of the cleaning device, in particular the nylon threads or steel wool threads, and/or cleaning strips come into contact with the surface to be cleaned, in particular the flat surface, through the sliding device.

In particular, only the cleaning threads and/or cleaning strips attracted by centrifugal force touch the surface to be cleaned, in particular the flat surface.

In particular, the aircraft, in particular the cleaning device, can be designed without a tank.

If necessary, it is provided that the aircraft comprises a chassis, in particular a frame, wherein the chassis is designed to accommodate the drive device, the payload and/or external force effects.

If necessary, it is provided that the at least one drive device is arranged on the chassis.

If necessary, it is provided that a safety device, in particular a safety housing and/or a rotor protection, is/are provided.

Optionally, it is provided that the safety device essentially completely surrounds the at least one drive device, in particular the at least one rotor of the at least one drive device.

If necessary, it is provided that the chassis is part of the safety device.

If necessary, it is provided that the chassis and the safety device are formed in one piece.

In particular, the safety device is optionally designed as a chassis and is preferably designed to accommodate the drive device, the payload and/or external force effects.

In particular, the safety device is optionally designed to accommodate the drive device, the payload and/or external force effects. If necessary, the safety device can act as a chassis.

Rotor protection is an additional component, in particular in conventional drones. In the aircraft according to the invention, the safety device can be designed to carry the drive devices and/or to ensure the stability of the aircraft.

Optionally, it is provided that the safety device essentially completely surrounds the at least one rotor of the drive device, in particular the four rotors of the drive device(s).

If necessary, it is provided that the safety device essentially completely surrounds all rotors of the aircraft.

If necessary, it is provided that the safety device is made of plastic or carbon. If necessary, it is provided that the safety device comprises plastic or carbon.

The safety device can in particular be at least partially honeycomb-shaped.

If necessary, it is provided that the at least one sensor is designed to detect the surface.

If necessary, it is provided that the at least one sensor is designed to detect the boundaries, in particular of at least part of the frame, of the surface.

If necessary, it is provided that the at least one sensor for stabilizing the aircraft is designed on the surface.

If necessary, it is provided that the at least one sensor is configured to determine the position of the aircraft on the surface.

If necessary, it is provided that the at least one sensor is configured to detect the distance from the aircraft to the frame.

If necessary, it is provided that the at least one sensor is configured to detect the distance from the aircraft to the surface.

If necessary, it is provided that the aircraft comprises a spacing device.

If necessary, it is provided that the spacing device is configured to stabilize the aircraft on the surface.

If necessary, it is provided that the spacing device is configured to maintain a distance between the aircraft and the surface.

If necessary, it is provided that the cleaning device is designed as a spacing device.

If necessary, it is provided that the at least one sensor is designed as a spacing device.

If necessary, it is provided that the at least one sensor and/or the cleaning device is configured to stabilize the aircraft on the surface. If necessary, it is provided that the at least one sensor and/or cleaning device is configured to maintain a distance between the aircraft and the surface.

If necessary, it is provided that the at least one sensor is designed as a traceball, trackball, laser, lidar, time of flight, camera and/or limit switch.

If necessary, it is provided that at least two sensors, in particular four sensors, are arranged on the aircraft.

If necessary, it is provided that the sensors are arranged on the aircraft in such a way that the sensors are each aligned with a different part of the window.

If necessary, it is provided that the sensors are arranged on the aircraft in such a way that the sensors are each aligned with a different part of the frame of the surface.

If necessary, it is provided that the sensors detect in particular the part of the surface and/or the distance from the part of the surface on which the sensors are aligned.

If necessary, it is provided that the sensors detect in particular the part of the frame and/or the distance from the part of the frame on which the sensors are aligned.

If necessary, it is provided that the at least two sensors, in particular the four sensors, simultaneously detect the parts of the frame and/or the distance from the parts of the frame.

The at least one sensor can optionally be configured to detect the frame of the surface, in particular the window frame or door frame, in particular using laser technology.

The at least one sensor can optionally be configured to detect the distance from the sensor and the frame of the surface, in particular the window frame or door frame, in particular using laser technology.

In particular, it is provided that the at least one sensor, in particular four sensors, is/are arranged on the aircraft in such a way that they detect the frame, in particular the different frame parts. If necessary, the distance from the frame, in particular the different parts of the frame, can be detected by the at least one sensor, in particular four sensors, preferably simultaneously.

In particular, the at least one sensor is configured to detect the inner edge of the frame, in particular the distance of the sensor from the inner edge of the frame.

In particular, the at least one sensor is configured to detect the position of the aircraft on the surface independently of the detection of the frame. In other words, it can be provided that the at least one sensor is configured to determine the position of the aircraft without the distance from the frame being determined. This may be necessary for frameless surfaces.

In particular, the at least one sensor is configured to detect the distance between the aircraft and the surface independently of the detection of the frame. In other words, it can be provided that the at least one sensor is configured to determine the distance between the aircraft and the surface without the distance from the frame being determined. This may be necessary for frameless surfaces.

Optionally, the at least one sensor, in particular four sensors, is/are arranged on the aircraft in such a way that the sensor signal emitted by at least one sensor, in particular the laser pulse, strikes the frame, preferably the inner edge of the frame, at an angle in the range from 85° to 95°, in particular essentially 90°.

The controller can be configured, preferably exclusively, to control, navigate and/or stabilize the aircraft, preferably on the surface, based on the distance from the frame measured by the at least one sensor, in particular automatically.

The controller can be configured, preferably exclusively, to control, navigate and/or stabilize the aircraft, preferably on the surface, based on the position of the aircraft on the surface detected by the at least one sensor, in particular automatically.

In particular, it can be provided that the at least one sensor is gimbal-mounted on the aircraft.

If necessary, it is intended that the aircraft has a weight in the range from 50 grams to 250 grams inclusive.

In particular, it is envisaged that the aircraft only weighs a quarter of the weight of conventional window cleaning robots.

If necessary, it is provided that the aircraft can be operated unsecured to the window.

If necessary, it is provided that the aircraft comprises additional sensors.

If necessary, it is provided that the aircraft comprises at least one GPS sensor, at least one altimeter, at least one pressure meter, at least one movement meter, at least one distance meter, at least one temperature sensor, at least one touch sensor and/or at least one gyrometer.

If necessary, it is provided that the aircraft comprises an energy storage device.

In particular, the invention relates to a method for cleaning, in particular substantially flat surfaces, which may be delimited by a frame, in particular a window or door frame, with an aircraft, in particular a drone.

The method can comprises the following steps:
arranging, in particular manually stopping, the deactivated, in particular switched off, aircraft on the surface,
activating, in particular switching on, the aircraft, so that at least one drive device of the aircraft is activated, in particular at least one rotor of the drive device is set in rotation,
releasing the activated aircraft, whereby the aircraft then independently cleans the area.

In particular, it can be provided that the distance between the aircraft and the surface remains essentially the same during cleaning, i.e. after activation of the aircraft.

The aircraft can move up and down the surface as well as to the left and to the right during cleaning. The aircraft preferably only moves in one plane during cleaning.

In particular, it can be provided that the aircraft constantly touches the surface via the cleaning device, the sliding device, the spacing device and/or the at least one sensor while cleaning the surface.

If necessary, it is provided that the method steps of the method follow one another as described above.

In this case, it can be provided that the deactivated aircraft is first arranged on the surface, in particular by a person. The aircraft can then be activated. Subsequently or simultaneously, the activated aircraft can be released.

In all embodiments it is preferably provided that the method according to the invention is automated, in particular controlled and/or regulated by a controller of the aircraft.

If necessary, it can be provided that the movement of the aircraft on the surface is controlled and/or regulated by a controller.

If necessary, it can be provided that the controller processes data from the sensor connected to the controller for control purposes.

If necessary, it can be provided that the frame of the surface, in particular the frame of the door or the frame of the window, is detected by the sensor.

If necessary, it can be provided that the position of the aircraft on the surface is detected by the sensor.

In particular, the sensor can detect the inner edge of the frame, in particular the distance of the sensor from the inner edge of the frame.

In particular, the sensor can directly detect the inner edge of the frame, in particular by abutting it.

In particular, the position of the aircraft on the surface can be detected by the sensor.

If necessary, it is provided that the position of the aircraft on the surface can be determined by detecting the distance from the frame by the sensor.

If necessary, it is provided that the position of the aircraft on the surface can be determined by detecting the movement of the aircraft by the sensor.

If necessary, it is provided that the movement of the aircraft on the surface is changed if the distance from the boundaries, in particular from at least part of the frame, of the surface falls below a predefined value.

If necessary, it is provided that the direction of movement of the aircraft on the surface is reversed if the distance from the boundaries, in particular to at least part of the frame, of the surface falls below a predefined value.

In particular, it can be provided that the movement of the aircraft on the surface is changed when the at least one sensor abuts at least part of the frame of the surface.

If necessary, it is provided that the aircraft moves in a first direction on the surface. In particular, the aircraft moves in a second direction when the distance from the boundaries of the surface falls below a predetermined or defined value or the at least one sensor hits the frame.

The first direction can optionally be opposite to the second direction.

If necessary, it is provided that the aircraft is controlled by the controller in such a way that a holding device arranged on the aircraft is pressed against the surface, so that the aircraft is fixed to the surface.

If necessary, it is provided that the aircraft is controlled by the controller in such a way that a holding device arranged on the aircraft is pressed against the surface, so that the aircraft is fixed to the surface when the cleaning of the surface is completed.

If necessary, it is provided that the aircraft is controlled by the controller in such a way that a holding device arranged on the aircraft is pressed against the surface, so that the aircraft is fixed to the surface when the capacity of the energy storage is less than 20%, less than 15% or less than 10%.

If necessary, it is provided that the aircraft is controlled by the controller in such a way that a holding device arranged on the aircraft is pressed against the surface, so that the aircraft is fixed to the surface when a malfunction is detected by a controller.

If necessary, it is provided that the aircraft is deactivated, in particular switched off, when the aircraft is fixed to the surface via the holding device, so that the drive device, in particular the rotation of the at least one rotor of the drive device, is stopped.

If necessary, it is provided that the aircraft is fixed to the surface via the holding device after cleaning, in particular automatically.

As soon as the aircraft is fixed to the surface via the holding device, it can be provided that the drive device is deactivated, in particular the at least one rotor is switched off.

The aircraft can only be fixed to the surface using the holding device.

If necessary, it is provided that the method comprises the following further step: rotating the cleaning roller by the rotating device, so that the top of the cleaning roller is moved towards the surface, in particular in a first direction, when the aircraft ascends along the surface, so that the ascent of the aircraft is supported by the rotation of the cleaning roller.

If necessary, it is provided that the method comprises the following further step: rotating the cleaning roller by the rotating device, so that the top of the cleaning roller is moved opposite to the first direction when the aircraft descends along the surface, so that the descent of the aircraft is supported by the rotation of the cleaning roller.

If necessary, it is provided that the aircraft, in particular the controller, is controlled wirelessly by a transmitting device, in particular a computer, preferably a smartphone and/or a tablet.

In particular, it can be provided that in a first operating mode of the aircraft, the aircraft, in particular the controller, can only be controlled, in particular automatically, based on the data from the at least one sensor.

In particular, it can be provided that in a second operating mode of the aircraft, the aircraft, in particular the controller, can be controlled by a transmitting device.

If necessary, it is provided that the method is carried out using an aircraft designed according to the invention.

In particular, the aircraft according to the invention, preferably its controller, is optionally configured to carry out the method according to the invention and/or to be used for the method according to the invention.

Further features according to the invention may emerge from the claims, the description of the exemplary embodiments and the figures.

The invention will now be further explained using exemplary, non-exclusive and/or non-limiting exemplary embodiments.

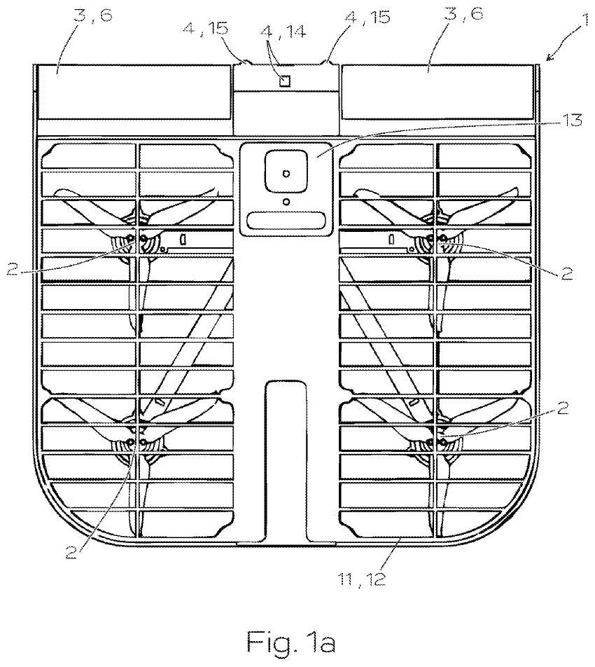

FIGS. 1a and 1b show a schematic graphic representation of a first embodiment of the aircraft according to the invention,

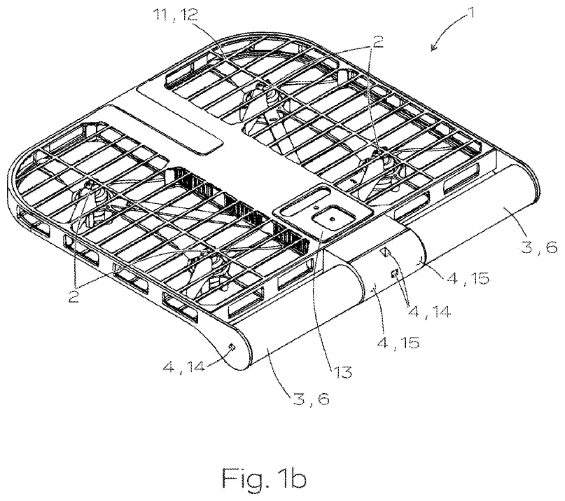

FIG. 2 shows a schematic graphic representation of the aircraft according to the invention while cleaning a flat surface, and

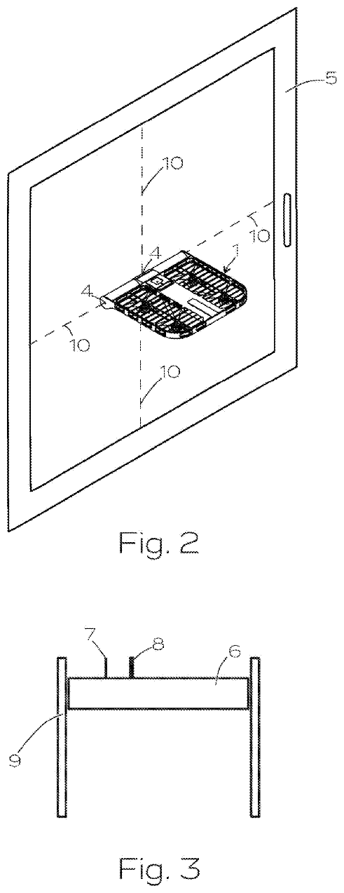

FIG. 3 shows a first embodiment of the cleaning device with sliding devices of an embodiment of the aircraft according to the invention.

Unless otherwise stated, the reference numbers correspond to the following components: aircraft 1, drive device 2, cleaning device 3, sensor 4, frame 5, cleaning roller 6, cleaning threads 7, cleaning strips 8, sliding device 9, sensor signals 10, chassis 11, safety device 12, holding device 13, lidar sensor 14 and traceball 15.

FIGS. 1a and 1b show a schematic graphic representation of the aircraft 1 according to the invention in a plan view and a three-dimensional representation.

The aircraft 1 according to this embodiment is designed as a drone. The aircraft 1 is designed to clean in particular substantially flat surfaces, which are delimited by a frame, in particular a window or door frame.

According to this embodiment, the aircraft 1 comprises four drive devices 2, a controller, an energy storage device and a cleaning device 3.

Furthermore, seven sensors 4 are provided on the aircraft 1.

According to this embodiment, five of these seven sensors 4 are designed as lidar sensors 14 and are configured to detect the distance from the frame 5 and/or the distance from the surface.

Four of the five sensors 4 are designed to detect at least part of the frame and the distance between the aircraft 1 and the frame 5.

These four sensors 4 are arranged on the aircraft 1 in such a way that the sensors 4 are each aligned with a different part of the frame 5. Furthermore, these four sensors 4 are provided on the aircraft 1 in such a way that the sensors 4 detect the part of the frame 5 and/or the distance from the part of the frame 5 on which the sensors 4 are aligned.

Furthermore, these four sensors 4 are arranged on the aircraft 1 in such a way that the sensor signals emitted by the sensors 4, in particular the laser pulse, are directed essentially at right angles to the respective frame part.

The fifth sensor 4 is arranged on the aircraft 1 in such a way that the distance from the aircraft 1 to the surface can be detected.

In addition, according to this embodiment, two sensors 4 are provided on the aircraft 1, which are designed as traceballs 15. These two sensors 4 are configured to detect the position of the aircraft 1 on the surface independently of the detection of the frame 5.

According to this embodiment, a holding device 13 is provided on the aircraft 1. The holding device 13 is designed to secure the aircraft 1 to the surface in a materially bonded manner. According to this embodiment, the holding device 13 comprises an adhesive tape.

The cleaning device 3 of the aircraft 1 comprises a cleaning roller 6 which can be rotated by a rotating device, wherein the rotating device is arranged inside the cleaning roller 6.

According to this embodiment, the aircraft 1 comprises a safety device 12, which is designed as a chassis 11, wherein the safety device 12 is designed to accommodate the at least one drive device 2, the payload and/or the external force effects.

The four drive devices 2 are arranged on the safety device 12. Furthermore, the safety device 12 essentially completely surrounds the drive devices 2 and the rotors thereof.

According to this embodiment, the aircraft 1 has a weight in the range from 50 grams to 250 grams inclusive.

In another embodiment, which is also claimed, instead of or in addition to the sensors 4 designed as lidar sensors 14, a sensor 4 can be provided which is configured to detect the frame 5, in particular when the aircraft 1 hits the frame 5. This sensor 4 can be designed as a limit switch.

FIG. 2 shows a schematic graphic representation of the aircraft 1 according to the invention while cleaning an area delimited by a frame 5. The features of the aircraft 1 according to FIG. 2 can preferably correspond to the features of the embodiments according to FIGS. 1a and/or 1b.

In this embodiment, the aircraft 1 is arranged on the surface. The distance between the aircraft 1 and the surface remains essentially the same during cleaning, i.e. after the aircraft 1 has been activated.

It is intended that the aircraft 1 constantly touches the surface via the cleaning device 3 while cleaning the surface.

The sensors 4 of the aircraft 1 detect the inner edge of the frame 5, in particular the distance of the sensor 4 from the inner edge of the frame 5.

Furthermore, the position of the aircraft 1 on the surface can be determined via the sensors 4, which are designed as a traceball 15.

The aircraft 1 is configured to carry out the cleaning method according to the invention.

To clean, in particular substantially flat surfaces which may be delimited by a frame 5, in particular a window or door frame, the deactivated, in particular switched off, aircraft 1, in particular a drone, is first arranged on the surface, in particular by stopping it manually.

The aircraft 1 can then be activated, in particular switched on, so that at least one drive device 2 of the aircraft 1 is activated, in particular at least one rotor of the drive device 2 is set in rotation.

Subsequently or simultaneously, the activated aircraft 1 can be released. The aircraft 1 can then carry out cleaning of the area independently.

The aircraft 1 moves up and down on the surface and to the left and to the right. In other words, the aircraft 1 only moves in one plane. The distance between the aircraft 1 and the surface remains essentially the same according to this embodiment.

The movement of the aircraft 1 on the surface is controlled and/or regulated by a controller.

For control purposes, the controller processes data from a sensor 4 connected to the controller, wherein the frame 5 of the surface, in particular the frame 5 of the door or the frame 5 of the window, is detected by the sensor 4.

In another embodiment, which is also claimed, the position of the aircraft 1 on the surface can be determined by the sensor 4 independently of the detection of the frame.

The aircraft 1 is controlled by the controller in such a way that a holding device 13 arranged on the aircraft 1 is pressed against the surface, so that the aircraft 1 is fixed to the surface, in particular when the cleaning of the surface is ended when the capacity of the energy storage device is below 20%, less than 15% or less than 10%, and/or when a malfunction is detected by a controller.

As soon as the aircraft 1 is fixed to the surface via the holding device 13, the aircraft 1 can be deactivated, in particular switched off, and in particular the rotation of the at least one rotor of the drive device 2 can be stopped.

The aircraft 1, in particular the controller, can be controlled wirelessly by a transmitting device, in particular a computer, preferably a smartphone and/or a tablet.

FIG. 3 shows a schematic graphic representation of a first embodiment of the cleaning device 3 with sliding devices 9 of the aircraft 1 according to the invention. The features of the aircraft 1 according to FIG. 3 can preferably correspond to the features of the embodiments according to FIGS. 1a, 1b and/or 2.

According to this embodiment, cleaning threads 7, in particular nylon threads or steel wool threads, and/or cleaning strips 8 are arranged on the cleaning device 3 of the aircraft 1, which is designed as a cleaning roller 6. The cleaning threads 7 and cleaning strips 8 are designed in such a way that they can be pressed onto the surface and/or attracted to the surface by centrifugal force.

The cleaning device 3 comprises a sliding device 9. The sliding device 9, in particular in its end regions, projects beyond the cleaning device 3, so that the cleaning device 3 is arranged at a distance from the surface to be cleaned during cleaning and in particular only the cleaning threads 7 and/or the cleaning strips 8 of the cleaning device 3 come into contact with the surface to be cleaned.

The effects according to the invention can be achieved through this exemplary configuration.

The invention is not limited to the illustrated embodiments, but comprises any aircraft 1 and methods according to the following claims.

1. An aircraft (1), in particular a drone, for cleaning surfaces, in particular substantially flat surfaces, which are delimited in particular by a frame (5), preferably a window or door frame, comprising
at least one drive device (2), in particular four drive devices (2),
a controller,
and a cleaning device (3),
characterized
in that at least one sensor (4) is provided on the aircraft (1),
and in that the at least one sensor (4) is designed to control the aircraft on the surface.

2. The aircraft (1) according to claim 1, characterized
in that a holding device (13) is provided on the aircraft (1),
and in that the holding device (13) is designed to fix the aircraft (1) to the surface, in particular in a materially bonded and/or frictional manner,
wherein the holding device (13) optionally comprises an adhesive tape
or wherein the holding device (13) is optionally designed as a suction cup.

3. The aircraft (1) according to any one of claim 1 or 2, characterized
in that the cleaning device (3) comprises a cleaning roller (6) which can be rotated by a rotating device, in particular an electric motor,
and in that the rotating device is arranged inside the cleaning roller (6) if necessary.

4. The aircraft (1) according to any one of the preceding claims, characterized
in that the cleaning device (3) comprises a substantially plate-shaped cleaning cloth,
and in that, if necessary, the cleaning cloth is pivotably connected to the aircraft (1) via a connecting device, in particular an eccentric.

5. The aircraft (1) according to any one of the preceding claims, characterized
in that the end regions, in particular the corners, of the cleaning device (3) are rounded,
and/or in that the cleaning device (3) is connected to the aircraft (1) via a shock absorber device.

6. The aircraft (1) according to any one of the preceding claims, characterized
in that cleaning threads (7), in particular nylon threads or steel wool threads, and/or cleaning strips (8) are arranged on the cleaning device (3), in particular the cleaning roller (6) and/or the cleaning cloth,
and in that the cleaning threads (7) and/or cleaning strips (8) are designed in such a way that they can be pressed onto the surface and/or attracted to the surface by centrifugal force.

7. The aircraft (1) according to any one of the preceding claims, characterized in that the cleaning device (3) comprises an ultrasonic device and/or a dry ice device for cleaning the surface to be cleaned.

8. The aircraft (1) according to any one of the preceding claims, characterized
in that the cleaning device (3) comprises a sliding device (9),
and in that the sliding device (9) projects beyond the cleaning device (3), in particular in its end regions, so that the cleaning device (3) is arranged at a distance from the surface to be cleaned during cleaning and in particular only the cleaning threads (7) and/or the cleaning strips (8) of the cleaning device (3) come into contact with the surface to be cleaned.

9. The aircraft (1) according to any one of the preceding claims, characterized
in that the aircraft (1) comprises a chassis (11), in particular a frame (5), wherein the chassis (11) is designed to accommodate the at least one drive device (2), the payload and/or external force effects,
in that the at least one drive device (2) is arranged on the chassis (11),
in that a safety device (12), in particular a safety housing and/or a rotor protection, is provided,
in that the safety device (12) essentially completely surrounds the at least one drive device (2), in particular the at least one rotor of the at least one drive device (2),
and in that the chassis (11) is part of the safety device (12).

10. The aircraft (1) according to any one of the preceding claims, characterized
in that the at least one sensor (4) is designed to detect the surface and/or to detect the boundaries, in particular of at least part of the frame, of the surface,
and/or in that the at least one sensor (4) is designed to stabilize the aircraft (1) on the surface,
and/or in that the at least one sensor (4) is configured to determine the position of the aircraft (1) on the surface,
and/or in that the at least one sensor (4) is configured to detect the distance of the aircraft (1) from the frame (5),
and/or in that the at least one sensor (4) is configured to detect the distance of the aircraft (1) from the surface.

11. The aircraft (1) according to any one of the preceding claims, characterized
in that the aircraft (1) comprises a spacing device,
and in that the spacing device is configured to stabilize the aircraft (1) on the surface and/or to maintain a distance between the aircraft (1) and the surface,
wherein, if necessary, the cleaning device (3) is designed as a spacing device,
and/or wherein optionally the at least one sensor (4) is designed as a spacing device.

12. The aircraft (1) according to any one of the preceding claims, characterized
in that the at least one sensor (4) is designed as a traceball, trackball, laser, lidar, time of flight, camera and/or limit switch.

13. The aircraft (1) according to any one of the preceding claims, characterized
in that at least two sensors (4), in particular four sensors (4), are arranged on the aircraft (1).
in that, if necessary, the sensors (4) are arranged on the aircraft (1) in such a way that the sensors (4) are each aligned with a different part of the surface, in particular the frame (5) of the surface,
whereby, if necessary, the sensors (4) detect the part of the surface, in particular the part of the frame (5), and/or the distance from the part of the surface, in particular the part of the frame (5) of the surface, on which the sensors (4) are aligned,
in that, if necessary, the at least two sensors (4), in particular the four sensors (4), simultaneously detect the parts of the frame (5) and/or the distance from the parts of the frame (5).

14. The aircraft (1) according to any one of the preceding claims, characterized in that the aircraft (1) has a weight in the range from 50 grams to 250 grams inclusive.

15. The aircraft (1) according to any one of the preceding claims, characterized
in that the aircraft (1) comprises further sensors (4), in particular a GPS sensor, an altimeter, a pressure meter, a movement meter, a distance meter, a temperature sensor, a touch sensor and/or a gyrometer,
and/or in that the aircraft (1) comprises an energy storage device.

16. A method for cleaning, in particular substantially flat surfaces which may be delimited by a frame, in particular a window or door frame, with an aircraft (1), in particular a drone,
comprising the following steps:
arranging, in particular manually stopping, the deactivated, in particular switched off, aircraft (1) on the surface,
activating, in particular switching on, the aircraft (1), so that at least one drive device (2) of the aircraft (1) is activated, in particular at least one rotor of the drive device (2) is set in rotation,
releasing the activated aircraft (1), whereby the aircraft (1) then independently cleans the area.

17. The method according to claim 16, characterized
in that the movement of the aircraft (1) on the surface is controlled and/or regulated by a controller,
and in that data from a sensor (4) connected to the controller is processed by the controller for control purposes,
wherein the frame (5) of the surface, in particular the frame (5) of the door or the frame (5) of the window, is optionally detected by the sensor (4),
and/or wherein the position of the aircraft (1) on the surface is detected by the sensor (4).

18. The method according to any one of claim 16 or 17, characterized
in that the movement of the aircraft (1) on the surface is changed if the distance from the boundaries, in particular from at least part of the frame (5), of the surface falls below a predefined value,
and/or in that the direction of movement of the aircraft (1) on the surface is reversed if the distance from the boundaries, in particular from at least part of the frame (5), of the surface falls below a predefined value,
and/or in that the movement of the aircraft (1) on the surface is changed if the at least one sensor abuts at least part of the frame (5) of the surface.

19. The method according to any one of the preceding claims 16 to 18, characterized
in that the aircraft (1) is controlled by the controller in such a way that a holding device (13) arranged on the aircraft (1) is pressed against the surface, so that the aircraft (1) is fixed to the surface, in particular
when the cleaning of the area is finished,
and/or when the capacity of the energy storage device is less than 20%, less than 15% or less than 10%,
and/or when a malfunction is detected by a controller,
and in that the aircraft (1) is deactivated, in particular switched off, when the aircraft (1) is fixed to the surface via the holding device (13), so that the drive device (2), in particular the rotation of the at least one rotor of the drive device (2), is stopped.

20. The method according to any one of claims 16 to 19, characterized in that the method comprises the following further steps:
rotating the cleaning roller (6) by the rotating device, so that the top of the cleaning roller (6) is moved towards the surface, in particular in a first direction, when the aircraft (1) ascends along the surface, so that the ascent of the aircraft (1) is supported by the rotation of the cleaning roller (6),
rotating the cleaning roller (6) by the rotating device, so that the top of the cleaning roller (6) is moved opposite to the first direction when the aircraft (1) descends along the surface, so that the descent of the aircraft (1) is supported by the rotation of the cleaning roller (6).

21. The method according to any one of claims 16 to 20, characterized in that the aircraft (1), in particular the controller, is controlled wirelessly by a transmitting device, in particular a computer, preferably a smartphone and/or a tablet.

22. The method according to any one of claims 16 to 21, characterized in that the aircraft (1) is designed according to any one of claims 1 to 15.
